(19) United States
(12) Patent Application Publication
(10) Pub. No.: US 2012/0264611 A1
(43) Pub. Date: Oct. 18, 2012

(54) Pesticide Preparations Containing Derivatives Of Pyrrolidone-4-Carboxylic Acid

(75) Inventors: Andreas Wacker, Mannheim (DE); Joachim Hess, Hofheim (DE); Robert Milbradt, Wiesbaden (DE); Franz-Xaver Scherl, Burgkirchen (DE)

(73) Assignee: CLARIANT FINANCE (BVI) LIMITED, Tortola (VG)

(21) Appl. No.: 13/497,975

(22) PCT Filed: Sep. 18, 2010
(86) PCT No.: PCT/EP10/05737

§ 371 Date: Apr. 20, 2012

(30) Foreign Application Priority Data
Sep. 25, 2009 (DE) 10 2009 043 122.5

(51) Int. Cl. A01N 25/00; A01P 7/04; A01P 13/00; A01P 3/00; A01N 25/02; A01N 25/04

(52) U.S. Cl. 504/365; 504/358; 514/784; 514/785; 514/788

(57) ABSTRACT

The invention relates to pesticide preparations that contain one or more pesticides and one or more N-substituted 2-pyrrolidone-4-carboxylic acid derivatives and to the use of said pesticide preparations for controlling and/or combating weeds, fungal diseases, or insect infestation. The N-substituted 2-pyrrolidone-4-carboxylic acid derivatives act as adjuvants, emulsifiers, dispersants, and/or wetting agents in the pesticide preparations.

The present invention relates to pesticide preparations comprising pyrrolidone carboxylic acid derivatives, and to their use, and in particular for controlling and/or combating weeds, fungal diseases or infestation by insects.

Pesticides are usually employed in the form of a preparation to achieve better utilization of the active compound. Such preparations are also designated as formulations and are generally present in solid or in liquid form. The formulations comprise at least one auxiliary but in most cases a plurality of auxiliaries which have various functions.

Examples of auxiliaries are, according to their function, solvents, emulsifiers, wetting agents, dispersants, crystallization inhibitors, antifoams, preservatives, antioxidants, thickeners, antifreeze agents, humectants, colorants and adjuvants. Adjuvants are to be understood as meaning auxiliaries which increase the biological effectiveness of the active compound without displaying any biological action for their part, for example by improving wetting, retention or uptake into the plant or the target organism.

Examples of liquid preparations (“formulation types”) are aqueous solutions (SL), suspension concentrates (SC), suspo emulsions (SE), emulsifiable concentrates (EC), oil dispersions (OD), emulsions in water (EW) or microemulsions (ME).

Examples of solid preparations (“formulation types”) are water-soluble powders or granules (SP, SG) or water-dispersible powders or granules (WP, WDP, WG, WDG).

Many effective auxiliaries used in pesticide preparations are objectionable from a toxicological or ecotoxicological point of view, such as nonylphenol ethoxylates (owing to their endocrine action), fatty amine ethoxylates (ecotoxic properties) or N-methylpyrrolidone (reprotoxic properties).

Accordingly, one requirement for novel auxiliaries and pesticide preparations is their toxicological and ecotoxicological benignancy.

A further important fundamental requirement for auxiliaries in pesticide preparations is that they have no damaging effect on the crop plant (phytotoxicity). This is of major importance especially for fungicides, insecticides and selective herbicides, but also for non-selective herbicides, for example when used in genetically modified crop plants which are distinguished by resistance to the corresponding non-selective herbicides.

Accordingly, it was an object of the present invention to provide pesticide preparations comprising auxiliaries distinguished by good efficacy, toxicological and ecotoxicological benignancy and low phytotoxicity.

Surprisingly, it has now been found that this object is achieved by using N-substituted 2-pyrrolidone-4-carboxylic acid derivatives in pesticide preparations, and that N-substituted 2-pyrrolidone-4-carboxylic acids and their salts, esters and amides are particularly suitable as effective auxiliaries for pesticide preparations.

Accordingly, the present invention provides pesticide preparations comprising

a) one or more pesticides and
b) one or more N-substituted 2-pyrrolidone-4-carboxylic acid derivatives.

In the context of the present invention, “N-substituted 2-pyrrolidone-4-carboxylic acid derivatives” are to be understood as meaning both the N-substituted 2-pyrrolidone-4-carboxylic acids and other derivatives such as, in particular, the salts, esters and amides of the N-substituted 2-pyrrolidone-4-carboxylic acids.

U.S. Pat. No. 2,757,125 describes N-alkyl-4-carboxy-2-pyrrolidone and its salts, certain alkyl esters and alkylamides which are used as antibacterial components in cosmetic formulations or cleaning compositions.

U.S. Pat. No. 2,977,309 describes a lubricant oil which comprises a reaction product of itaconic acid and branched primary aliphatic amines having 10-24 carbon atoms.

U.S. Pat. No. 3,224,975 describes lubricant compositions comprising N-alkyl-4-carboxy-2-pyrrolidone, where the alkyl radical comprises 8-25 carbon atoms.

GB 1323061 discloses certain N-substituted 4-carboxy-2-pyrrolidones and their use in functional fluids such as, for example, hydraulic fluids.

EP 2 022 781 describes dimeric N-alkyl-4-carboxy-2-pyrrolidone derivatives which are attached via a bridge at the carboxyl group, and their use as gas hydrate inhibitors.

EP 2 028 247 describes the use of N-alkyl-2-pyrrolidone-4-carboxylic esters as gas hydrate inhibitors.

WO 2009/086872 and WO 2009/086873 describe the use of N-alkyl-2-pyrrolidone-4-carboxylic acid ammonium salts as corrosion inhibitors.

However, the use of pyrrolidone carboxylic acid derivatives as auxiliaries in pesticide formulations has not been described.

In the context of the present invention, pesticides are to be understood as meaning herbicides, fungicides, insecticides, acaricides, bactericides, molluscicides, nematicides and rodenticides, and also phytohormones. Phytohormones control physiological reactions such as growth, flowering rhythm, cell division and seed maturation. A review of the most relevant pesticides can be found, for example, in “The Pesticide Manual” of the British Crop Protection Council, 14th Edition 2006, Editor: C D S Tomlin.

The one or more pesticides of component a) of the pesticide preparations according to the invention are preferably selected from the group consisting of herbicides, insecticides and fungicides.

Preferred fungicides are aliphatic nitrogen fungicides, amide fungicides such as acylamino acid fungicides or anilide fungicides or benzamide fungicides or strobilurin fungicides, aromatic fungicides, benzimidazole fungicides, benzothiazole fungicides, carbamate fungicides, conazole fungicides such as imidazoles or triazoles, dicarboximide fungicides, dithiocarbamate fungicides, imidazole fungicides, morpholine fungicides, oxazole fungicides, pyrazole fungicides, pyridine fungicides, pyrimidine fungicides, pyrrole fungicides, quinone fungicides.

Preferred herbicides are amide herbicides, anilide herbicides, aromatic acid herbicides such as benzoic acid herbicides or picolinic acid herbicides, benzoylcyclohexanedione herbicides, benzofuranylalkylsulfonate herbicides, benzothiazole herbicides, carbamate herbicides, carbanilate herbicides, cyclohexene oxime herbicides, cyclopropylisoxazole herbicides, dicarboximide herbicides, dinitroaniline herbicides, dinitrophenol herbicides, diphenyl ether herbicides, dithiocarbamate herbicides, imidazolinone herbicides, nitrile herbicides, organophosphorous herbicides, oxadiazolone herbicides, oxazole herbicides, phenoxy herbicides such as phenoxyacetic acid herbicides or phenoxybutanoic acid herbicides or phenoxypropionic acid herbicides or aryloxyphenoxypropionic acid herbicides, pyrazole herbicides such as benzoylpyrazole herbicides or phenylpyrazole herbicides, pyridazinone herbicides, pyridine herbicides, thiocarbamate herbicides, triazine herbicides, triazinone herbicides, triazole herbicides, triazolone herbicides, triazolopyrimidine herbicides, uracil herbicides, urea herbicides such as phenylurea herbicides or sulfonylurea herbicides.

Preferred insecticides are carbamate insecticides such as benzofuranyl methylcarbamate insecticides or dimethylcarbamate insecticides or oxime carbamate insecticides or phenyl methylcarbamate insecticides, diamide insecticides, insect growth regulators, macrocyclic lactone insecticides such as avermectin insecticides or milbemycin insecticides or spinosyn insecticides, nereistoxin analog insecticides, nicotinoid insecticides such as nitroguanidine nicotinoid insecticides or pyridylmethylamine nicotinoid insecticides, organophosphorus insecticides or organophosphate insecticides or organothiophosphate insecticides or phosphonate insecticides or phosphoramidothioate insecticides, oxadiazine insecticides, pyrazole insecticides, pyrethroid insecticides such as pyrethroid ester insecticides or pyrethroid ether insecticides or pyrethroid oxime insecticides, tetramic acid insecticides, tetrahydrofurandione insecticides, thiazole insecticides.

Particularly preferably, the one or more pesticides of component a) of the pesticide preparations according to the invention are selected from the group consisting of aryloxyphenoxypropionic acid herbicides, benzoylcyclohexanedione herbicides, triazolopyrimidine herbicides, strobilurin fungicides, triazole fungicides, nicotinoid insecticides and pyrethroid insecticides.

Especially preferably, the one or more pesticides of component a) of the pesticide preparations according to the invention are selected from the group consisting of malathion, cypermethrin, glyphosate in the form of the acid and glyphosate in the form of salts. From among these, preference is given to glyphosate in the form of the acid and in the form of salts. From among the salts of glyphosate, glyphosate isopropylammonium is preferred.

A review of the pesticides and their classification into the corresponding pesticide classes can be found, for example, in “The Pesticide Manual” of the British Crop Protection Council, 14th Edition 2006, Editor: C D S Tomlin.

The biological activity of a pesticide can be determined by the plant growth or the damage to the plants owing to the action of the active compound on the leaf as a function of the duration of action and the active compound concentration.

The one or more N-substituted 2-pyrrolidone-4-carboxylic acid derivatives of component b) of the pesticide preparations according to the invention are preferably the N-substituted, preferably the N-alkyl- or N-alkenyl-substituted, 2-pyrrolidone-4-carboxylic acids and their salts, esters and amides.

Particularly preferably, the one or more N-substituted 2-pyrrolidone-4-carboxylic acid derivatives of component b) of the pesticide preparations according to the invention are selected from among the compounds of the formula (Z)

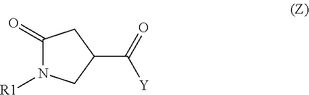

in which
R1 is C₈- to C₃₀-alkyl or C₈- to C₃₀-alkenyl,
Y is OM, —O[AO]ₙ—X or NR2R3,
M is hydrogen, an alkali metal or alkaline earth metal, ammonium NH₄⁺ or substituted ammonium, where the substituted ammonium is preferably selected from mono-, di- and trisubstituted ammonium and the substituents at the nitrogen atom of the substituted ammonium for their part are selected from alkyl groups having 1 to 4 carbon atoms and CH₂CH₂OH,
A is C₂- to C₄-alkylene or C₅H₅—(CH—CH₂),
n is a number from 0 to 100,
X is C₁- to C₂₀-alkyl, benzyl or a substituted aryl radical, where the substituted aryl radical is preferably selected from phenyl substituted by 1 to 3 substituents and these substituents for their part are selected from alkyl groups having 1 to 4 carbon atoms and styryl and, in the case that n is not 0, X may also be hydrogen,
R2 and R3 independently of one another are hydrogen, C₁- to C₂₀-alkyl or (C₂H₄O)ₚH and
p is a number from 1 to 20.

In an especially preferred embodiment of the invention, the one or more N-substituted 2-pyrrolidone-4-carboxylic acid derivatives of component b) of the pesticide preparations according to the invention are selected from among the compounds of the formula (1)

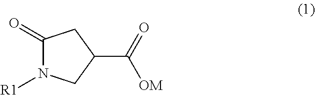

in which
R1 is C₈- to C₃₀-alkyl or C₈- to C₃₀-alkenyl, and
M is hydrogen, an alkali metal or alkaline earth metal, ammonium NH₄⁺ or substituted ammonium, where the substituted ammonium is preferably selected from mono-, di- and trisubstituted ammonium and the substituents at the nitrogen atom of the substituted ammonium for their part are selected from alkyl groups having 1 to 4 carbon atoms and CH₂CH₂OH.

In a further especially preferred embodiment of the invention, the one or more N-substituted 2-pyrrolidone-4-carboxylic acid derivatives of component b) of the pesticide preparations according to the invention are selected from among the compounds of the formula (2)

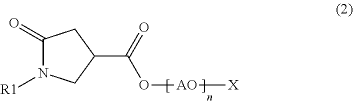

in which
R1 is C₈- to C₃₀-alkyl or C₈- to C₃₀-alkenyl,
A is C₂- to C₄-alkylene or C₆H₅—(CH—CH₂),
n is a number from 0 to 100, and
X is C₁- to C₂₀-alkyl, benzyl or a substituted aryl radical, where the substituted aryl radical is preferably selected from phenyl substituted by 1 to 3 substituents and these substituents for their part are selected from alkyl groups having 1 to 4 carbon atoms and styryl and, in the case that n is not 0, X may also be hydrogen.

In a further especially preferred embodiment of the invention, the one or more N-substituted 2-pyrrolidone-4-carboxylic acid derivatives of component b) of the pesticide preparations according to the invention are selected from among the compounds of the formula (3)

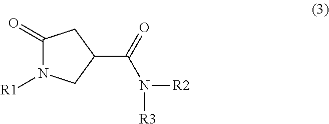

in which
R1 is C₈- to C₃₀-alkyl or C₈- to C₃₀-alkenyl,
R2 and R3 independently of one another are hydrogen, C₁- to C₂₀-alkyl or (C₂H₄O)ₚH and
p is a number from 1 to 20.

In the formulae (Z) and (1) to (3), R1 is preferably a straight-chain or branched alkyl or alkenyl group having 8 to 24 carbon atoms, in particular a straight-chain or branched alkyl or alkenyl group having 8 to 18 carbon atoms. Particularly preferably, R1 is a straight-chain or branched octyl radical, a cocoyl radical or an oleyl radical.

In the formulae (Z) and (1), M is preferably hydrogen, Na, K, Ca, ammonium, isopropylammonium, N,N-diethyl-(2-hydroxyethyl)ammonium, mono-, di- or triethanolammonium.

In the formulae (Z) and (2), A is preferably ethylene or propylene and particularly preferably ethylene. X is preferably hydrogen (if n is not zero), C₁- to C₄-alkyl and particularly preferably methyl. n is preferably from 1 to 40 and particularly preferably from 5 to 25.

If X in the formulae (Z) and (2) is a substituted aryl radical, this is preferably 2,4,6-tri-sec-butylphenyl or 2,4,6-tristyrylphenyl.

In the formulae (Z) and (3), R2 and R3 are preferably hydrogen, C₁- to C₄-alkyl or (C₂H₄O)ₚH. Particularly preferably, R2 and R3 are methyl or —CH₂—CH₂—OH.

Owing to the numerous options for varying the chemical structure of the N-substituted 2-pyrrolidone-4-carboxylic acid derivatives of component b) present in the pesticide preparations according to the invention and thereby adapting the physical and physicochemical properties of the molecules, the N-substituted 2-pyrrolidone-4-carboxylic acid derivatives may fulfill highly different tasks.

The N-substituted 2-pyrrolidone-4-carboxylic acid derivatives of component b) of the pesticide preparations according to the invention and in particular the compounds of the formulae (Z) and (1) to (3) are preferably suitable as adjuvants, emulsifiers, dispersants or wetting agents.

Accordingly, the present invention also provides the use of one or more N-substituted 2-pyrrolidone-4-carboxylic acid derivatives and preferably one or more N-substituted 2-pyrrolidone-4-carboxylic acid derivatives selected from the formulae (Z) and (1) to (3) as adjuvant, preferably in a pesticide preparation according to the invention.

The present invention also provides the use of one or more N-substituted 2-pyrrolidone-4-carboxylic acid derivatives and preferably one or more N-substituted 2-pyrrolidone-4-carboxylic acid derivatives selected from the formulae (Z) and (1) to (3) as emulsifier, preferably in a pesticide preparation according to the invention.

Particularly preferred emulsifiers are in this case compounds of the formula (1) in which M is not hydrogen (anionic emulsifiers) or compounds of the formula (2) in which n≧5 (nonionic emulsifiers).

Compounds of the formula (2) in which X is not hydrogen and n≧5 are particularly preferably suitable as emulsifiers for pesticide preparations comprising an active compound which is sensitive to water or to OH groups, such as, for example, sulfonylureas (SUs).

The present invention also provides the use of one or more N-substituted 2-pyrrolidone-4-carboxylic acid derivatives and preferably one or more N-substituted 2-pyrrolidone-4-carboxylic acid derivatives selected from the formulae (Z) and (1) to (3) as wetting agent, preferably in a pesticide preparation according to the invention.

Compounds of the formula (1) in which M is Na, K, ammonium NH₄⁺ or substituted ammonium are particularly suitable as wetting agents.

The present invention also provides the use of one or more N-substituted 2-pyrrolidone-4-carboxylic acid derivatives and preferably one or more N-substituted 2-pyrrolidone-4-carboxylic acid derivatives selected from the formulae (Z) and (1) to (3) as dispersant, preferably in a pesticide preparation according to the invention.

Compounds of the formula (1) in which M is Na, K, ammonium NH₄⁺ or substituted ammonium are particularly suitable as dispersants.

In a preferred embodiment of the invention, the pesticide preparations according to the invention can be present as liquid preparations (“formulation types”) selected from aqueous solutions (SL), suspension concentrates (SC), suspo emulsions (SE), emulsifiable concentrates (EC), oil dispersions (OD), emulsions in water (EW) or microemulsions (ME).

Compounds of the formula (1) in which M is not hydrogen or compounds of the formula (2) in which n≧10 are, by virtue of their solubility, particularly preferably suitable for use in water-containing formulations such as SLs, SCs, EWs, SEs and MEs.

Compounds of the formula (1) in which M is hydrogen or compounds of the formula (2) in which n≦9 or compounds of the formula (3) have a low solubility in water and are therefore particularly suitable as auxiliaries for solvent- or oil-containing preparations such as ECs, EWs, SEs, MEs and ODs.

In a further preferred embodiment of the invention, the pesticide preparations according to the invention are present as solid preparations (“formulation types”) selected from water-soluble powders or granules (SP, SG) or water-dispersible powders or granules (WP, WDP, WG, WDG).

Compounds of the formulae (Z) and (1) to (3) which are distinguished by a melting point of preferably >30° C. and particularly preferably >40° C. are particularly preferably suitable for use in solid preparations.

The present invention also provides the use of one or more N-substituted 2-pyrrolidone-4-carboxylic acid derivatives and preferably one or more N-substituted 2-pyrrolidone-4-carboxylic acid derivatives selected from the formulae (Z) and (1) to (3) for preparing pesticide preparations according to the invention.

The pesticide preparations according to the invention can be prepared by various routes depending on the formulation type, and the person skilled in the art is sufficiently familiar with the preparation.

The N-substituted 2-pyrrolidone-4-carboxylic acids of component b) of the pesticide preparations according to the invention can be obtained by reacting itaconic acid with primary amines and can be prepared as described in EP 0 069 512, U.S. Pat. No. 3,224,975 and U.S. Pat. No. 4,127,493.

The corresponding salts can be prepared by reacting the N-substituted 2-pyrrolidone-4-carboxylic acids with a base. Suitable bases are, preferably, NaOH, Ca(OH)₂, CaCO₃, KOH and amines such as ammonia, isopropylamine, mono-, di- or triethanolamine.

The corresponding esters can be prepared, for example, by adding alkylene oxides to the N-substituted 2-pyrrolidone-4-carboxylic acids or by condensation of the N-substituted 2-pyrrolidone-4-carboxylic acids with optionally substituted polyglycol ethers. The esters can also be prepared, for example, by esterification, known to the person skilled in the art, of N-substituted 2-pyrrolidone-4-carboxylic acids with alkyl alcohols, benzyl alcohol or other aromatic alcohols.

The corresponding amides can be obtained by condensation of the N-substituted 2-pyrrolidone-4-carboxylic acids with amines.

The pesticide preparations according to the invention comprise the one or more N-substituted 2-pyrrolidone-4-carboxylic acid derivatives of component b) preferably in amounts of from 0.1 to 50% by weight, particularly preferably from 0.5 to 30% by weight and especially preferably from 1 to 20% by weight. These quantities refer to the total pesticide preparation according to the invention.

The pesticide preparations according to the invention comprise the one or more pesticides of component a) preferably in amounts of from 1 to 90% by weight, particularly preferably from 2 to 80% by weight and especially preferably from 4 to 70% by weight. These quantities refer to the total pesticide preparation according to the invention.

The pesticide preparations according to the invention are particularly suitable for controlling and/or combating weeds, fungal diseases or infestation by insects.

Accordingly, the present invention also provides the use of a pesticide preparation according to the invention for controlling and/or combating weeds, fungal diseases or infestation by insects.

The pesticide preparations according to the invention are preferably applied to the fields in the form of spray liquors. A spray liquor is in this case prepared by diluting the concentrate formulation with a defined amount of water.

In a preferred embodiment of the invention, the pesticide preparation according to the invention is present as a spray liquor and comprises from 0.001 to 10% by weight, preferably from 0.02 to 3% by weight and particularly preferably from 0.025 to 2% by weight of the pesticide of component a) and from 0.001 to 3% by weight, preferably from 0.005 to 1% by weight and particularly preferably from 0.01 to 0.5% by weight of N-substituted 2-pyrrolidone-4-carboxylic acid derivative of component b). These quantities refer to the total spray liquor.

The weight ratio of the one or more N-substituted 2-pyrrolidone-4-carboxylic acid derivatives of component b) to the one or more pesticides of component a) in the spray liquor is preferably from 1:100 to 10:1 and particularly preferably from 1:20 to 4:1.

The amounts of pesticide applied per hectare are preferably in the range from 0.005 to 5 kg. The proportion of N-substituted 2-pyrrolidone-4-carboxylic acid derivatives is preferably in the range of from 0.002 to about 2.0 kg/ha. The volume of the spray liquor prepared for application is preferably in the range from 50 to 1000 l/ha.

Here, the one or more pesticides and the one or more N-substituted 2-pyrrolidone-4-carboxylic acid derivatives may also be present in the form of a tank mix preparation. In such a preparation, both the one or more pesticides and the one or more N-substituted 2-pyrrolidone-4-carboxylic acid derivatives are initially present separately. Prior to application, generally immediately beforehand, the two preparations are mixed with one another, and a preparation according to the invention is formed.

In the tank mix method, prior to mixing, the one or more pesticides are present as a formulation in water and/or in a solvent or as a solid formulation.

In the tank mix method, prior to mixing, the one or more N-substituted 2-pyrrolidone-4-carboxylic acid derivatives are present dissolved in water or in a solvent or in a water/solvent mixture.

The preparations according to the invention may comprise thickeners, solvents, dispersants, emulsifiers, preservatives, adjuvants, binders, thinners, disintegrants, wetting agents, penetrants, low-temperature stabilizers, colorants, antifoams and antioxidants.

Suitable for use as thickeners can be all substances which are customarily used for this purpose in agrochemical formulations, such as xanthan gum and/or cellulose, for example carboxy-, methyl-, ethyl- or propylcellulose or (optionally modified) bentonites in quantities by weight of from 0.01 to 5%, based on the finished composition. Suitable solvents are all substances customarily used for this purpose in agrochemical formulations, such as, for example, aromatic and aliphatic hydrocarbons, N-methylpyrrolidone, cyclohexanone, butyrolactone, acetophenone, lactic esters such as ethyl hexyl lactate, esters of carbonic acid such as propylene carbonate, fatty acid amides such as decanic acid dimethylamide, esters of phosphorous acid or phosphoric acid such as ethylhexylphosphonic acid bis(ethylhexyl) ester or tris(ethylhexyl) phosphate, glycols, polyethylene glycols, propylene glycol, natural and mineral oils, and also esters of fatty acids. Suitable dispersants and emulsifiers are all substances customarily used for this purpose in agrochemical formulations, such as nonionic, amphoteric, cationic and anionic (polymeric) surfactants. Suitable for use as preservatives can be all substances customarily used for this purpose in agrochemical formulations, such as organic acids and their esters, for example ascorbic acid, ascorbyl palmitate, sorbate, benzoic acid, methyl 4-hydroxybenzoate and propyl 4-hydroxybenzoate, propionates, phenol, for example 2-phenylphenate, 1,2-benzisothiazolin-3-one, formaldehyde, sulfurous acid and its salts. Suitable for use as adjuvants can be all substances customarily used for this purpose in agrochemical formulations, such as optionally cross-linked polyglycerol esters, alcohol alkoxylates such as, for example, alcohol ethoxylates, alkyl polysaccharides, fatty amine ethoxylates, esters of phosphorous acid or phosphoric acid such as ethylhexylphosphonic acid bis(ethylhexyl) ester or tris(ethylhexyl) phosphate, sorbitan and sorbitol ethoxylate derivatives and derivatives of alk(ene)ylsuccinic acid. Suitable penetrants are all substances customarily used to improve penetration of pesticides into plants or into target organisms. Penetrants can be defined, for example, in that they penetrate from the aqueous spray liquor and/or from a spray coating on the surface of the plant into the cuticle of the plant and are thus able to increase the motility (mobility) of active components in the cuticle. The method described in the literature can be used to determine this property (Baur et al., 1997, Pesticide Science 51, 131-152).

Suitable for solid formulations are all binders customarily used for this purpose in agrochemical formulations, such as polyvinylpyrrolidone, polyvinyl alcohol, carboxymethylcellulose, sugars, for example sucrose, sorbitol or starch. Suitable diluents, absorbers or carriers are all substances customarily used for this purpose in agrochemical formulations, such as carbon black, tallow, kaolin, aluminum stearate, calcium stearate or magnesium stearate, sodium tripolyphosphate, sodium tetraborate, sodium sulfate, silicates and sodium benzoate. Suitable for use as dispersants are all substances customarily used for this purpose in agrochemical formulations, such as cellulose, for example carboxymethylcellulose, polyvinylpyrrolidone, sodium acetate or potassium acetate, carbonates, bicarbonates, sesquicarbonates, ammonium sulfate or potassium hydrogen phosphate.

Suitable for use as wetting agents can be all substances customarily used for this purpose in agrochemical formulations, such as alcohol ethoxylates, alcohol alkoxylates, EO/PO block copolymers (EO: ethylene oxide unit; PO: propylene glycol unit) or optionally ethoxylated alkylsulfonic acids. All substances customarily used for this purpose in agrochemical formulations can be used as low-temperature stabilizers. Urea, glycerol and propylene glycol may be mentioned by way of example. Suitable colorants are all substances customarily used for this purpose in agrochemical formulations, such as water- or oil-soluble colorants, and also organic and inorganic pigments. Suitable antifoams are all substances customarily used for this purpose in agrochemical formulations, such as fatty acid alkyl ester alkoxylates; organopolysiloxanes such as polydimethylsiloxanes and mixtures thereof with microfine, optionally silanated silicic acid; perfluoroalkylphosphonates and perfluoroalkylphosphinates; paraffins, waxes and microcrystalline waxes and mixtures thereof with silanated silicic acid. Mixtures of different foam inhibitors, for example those of silicone oil, paraffin oil and/or waxes, are also advantageous. Suitable antioxidants are all substances customarily used for this purpose in agrochemical formulations, such as, for example, BHT (2,6-di-tert-butyl-4-methylphenol).

In addition, the preparations according to the invention may comprise one or more agrochemical salts, preferably potassium salts or ammonium salts.

### EXAMPLES

Hereinbelow, the invention is illustrated by examples; however, the examples are not to be considered as limiting the invention.

In the examples, percentages are % by weight unless explicitly stated otherwise.

### General Procedure for Preparing the N-Substituted 2-Pyrrolidone-4-Carboxylic Acids:

Primary amine is initially charged in a 2 liter stirrer apparatus with reflux condenser and receiver changer and heated to 100° C. while nitrogen is being passed over. At this temperature, the appropriate amount of itaconic acid is introduced in five portions of equal size, with gentle stirring. The mixture reacts exothermically, and after each portion the mixture is stirred for 30 minutes. The reaction mixture is then heated to reflux (about 120° C.) and kept under reflux for 6 hours. The receiver changer is then switched to removal of the water of reaction. Over a period of 4 hours, the temperature is gradually increased to 180° C. and the water of reaction is collected in the receiver.

### Example 1

According to the procedure above, 773.1 g of primary oleylamine (M=264.7 g/mol, Genamin® OL 100D from Clariant) and 400.0 g of itaconic acid (M=130.1 g/mol) are reacted. During the reaction, 50.2 g of water are removed. The product obtained has an acid number of 142.3 mg KOH/g (theory: 148.9 mg KOH/g). The water content is <0.05%. This gives 1072.7 g of N-oleyl-2-pyrrolidone-4-carboxylic acid (compound 1).

### Example 2

According to the procedure above, 683.5 g of primary coco fatty amine (M=195.5 g/mol, Genamin® CC 100D from Clariant) and 478.8 g of itaconic acid (M=130.1 g/mol) are reacted. During the reaction, 66.9 g of water are removed. The product obtained has an acid number of 173.0 mg KOH/g (theory: 182.4 mg KOH/g). The water content is <0.05%. This gives 1050.1 g of N-cocoyl-2-pyrrolidone-4-carboxylic acid (compound 2).

### Procedure for Preparing N-Substituted 2-Pyrrolidone-4-Carboxylic Esters.

The N-substituted 2-pyrrolidone-4-carboxylic acid and polyethylene glycol monomethyl ether (polyglycol M types from Clariant) are initially charged in a molar ratio of 1:1 in a 1 liter stirrer apparatus with reflux condenser, receiver changer and nitrogen being passed over the reaction, and the mixture is, with stirring, heated to 200° C. At this temperature, the mixture is stirred for a further 4 hours, and the water of reaction is distilled off. A water pump vacuum (22 mbar) is then carefully applied, and the mixture is heated to 220° C. Once the desired residual acid number is reached, the vacuum is broken with nitrogen and the mixture is allowed to cool. The individual experiments are summarized in table 1.

TABLE 1
Reactions of N-substituted 2-pyrrolidone-4-carboxylic acids with polyethylene glycol monomethyl ethers

| | | | | | | Residual acid | Hydroxyl | | |
|---|---|---|---|---|---|---|---|---|---|
| | | Amount | | Molar mass | Amount | number end | number end | | Appearance |
| | Pyrrolidone- | employed | Polyglycol | polyglycol M | employed | product | product | Yield | end product |
| Example | carboxylic acid | [g] | M | [g/mol] | [g] | [mg KOH/g] | [mg KOH/g] | [g] | at RT |
| Example 3 | Compound 1 | 420.0 | 250 | 283-295 | 303.2 | 2.1 | not | 682.7 | liquid |
| (Compound 3) | | | | | | | determined | | |
| Example 4 | Compound 1 | 380.0 | 350 | 330-370 | 329.0 | 2.3 | not | 664.2 | liquid |
| (Compound 4) | | | | | | | determined | | |
| Example 5 | Compound 1 | 387.5 | 500 | 470-530 | 312.5 | 1.7 | 4.2 | 665.0 | liquid |
| (Compound 5) | | | | | | | | | |
| Example 6 | Compound 1 | 238.7 | 750 | 720-780 | 462.3 | 0.6 | 4.7 | 676.5 | paste-like |
| (Compound 6) | | | | | | | | | |
| Example 7 | Compound 1 | 193.8 | 1000 | 970-1060 | 506.2 | 0.3 | not | 677.1 | solid |
| (Compound 7) | | | | | | | determined | | |
| Example 8 | Compound 2 | 279.2 | 500 | 470-530 | 420.7 | 1.3 | 4.9 | 643.3 | liquid |
| (Compound 8) | | | | | | | | | |
| Example 9 | Compound 2 | 208.7 | 750 | 720-780 | 491.2 | 0.7 | 6.0 | 653.7 | paste-like |
| (Compound 9) | | | | | | | | | |
| Example 10 | Compound 2 | 167.7 | 1000 | 970-1060 | 532.4 | 1.1 | 5.8 | 663.4 | paste-like |
| (Compound 10) | | | | | | | | | |

### Procedure for Preparing Salts of the N-Substituted 2-Pyrrolidone-4-Carboxylic Acids:

### Example 11

379 g of N-oleyl-2-pyrrolidone-4-carboxylic acid (compound 1) are reacted with 61 g of monoethanolamine. This gives 440 g of N-oleyl-2-pyrrolidone-4-carboxylic acid monoethanolammonium salt (compound 11) having an acid number=125 mg KOH/g and basic nitrogen N=3.3%.

### Example 12

311 g of N-cocoyl-2-pyrrolidone-4-carboxylic acid (compound 2) are reacted with 117 g of N,N-diethylaminoethanol. 428 g of N-cocoyl-2-pyrrolidone-4-carboxylic acid N,N-diethyl-(2-hydroxyethyl)ammonium salt (compound 12) having an acid number=125 mg KOH/g and basic nitrogen N=3.3% are obtained.

### Example 13

### Reaction of the N-Substituted 2-Pyrrolidone-4-Carboxylic Acids with Dimethylamine

2 mol of the N-substituted 2-pyrrolidone-4-carboxylic acid are initially charged in a 1 liter stirrer apparatus with reflux condenser and receiver changer, gaseous dimethylamine is introduced with heating to 180° C. and the water for reaction formed is continuously distilled off. Once the residual acid number has fallen to <5 mg KOH/g (after about 20 hours), introduction of dimethylamine is stopped and the excess dimethylamine is flushed out by introducing nitrogen under reduced pressure. The reaction mixture is then cooled while nitrogen is being passed over.

### Example 14

### Determination of Phytotoxicity

The phytotoxicity is determined on tomato plants (cv. Astona F1), a species which, as is known, is sensitive to phytotoxic substances taken up via the leaf surface (“Phototoxicity of different classes of adjuvants”, H. de Ruiter, et al., Proceedings Fifth International Symposium on Adjuvants for Agrochemicals, 1998, Ed. P. McMullan, pp. 204-209).

### Plants

Tomato plants (cv. Astona F1) are cultivated in a greenhouse under 14-hour light irradiation at a temperature of 18/12 (±0.5)° C. (day/night) and a relative atmospheric humidity of 70/80 (±5) % (day/night). 12 days after germination, the seedlings are transplanted into plastic pots having a diameter of 11 cm (one plant per pot) filled with a mixture of sand and soil (Soil No. 12, Colent b.v., Lent, the Netherlands) in a volume ratio of sand:soil=1:2.

The pots are placed on a subirrigation mat which was moistened daily with a nutrient solution of medium strength.

### Application

28 days after sowing, the plants were treated at the 4-leaf stage, each plant having a height of 15-17 cm. The auxiliary content of the spray solution was 0.5% (v/v or % by volume).

The spray solutions are applied to the plants using an air pressure-operated laboratory sprayer such that the resulting application rate is 200 l/ha.

The treated plants are scored visually after 2 and 8 days (DAT; DAT: days after treatment) and evaluated using a qualitative scale (1 to 5). Here, 1=no discoloration or necrosis of the leaves to 5=complete necrosis of the treated leaf surface. Moreover, the above-ground plant mass is determined after 8 days (fresh weight). In each case, the average is calculated, based on the number of treated plants. The reference substance used is a fatty alcohol alkoxylate as also used in pesticide preparations. The results are shown in table 2.

TABLE 2
Results of the treatment of the plant cv. Astona F1 with N-
substituted 2-pyrrolidone-4-carboxylic acid derivatives and
fatty alcohol alkoxylate, but without pesticide

| | | Visual | Visual | |
|---|---|---|---|---|
| | | evaluation | evaluation | Fresh weight |
| Experiment | Compound | (DAT 2) | (DAT 8) | [g] |
| 1 | Untreated | 1.0 | 1.0 | 8.6 |
| 2 | Compound 1 | 1.1 | 1.5 | 8.6 |
| 3 | Compound 5 | 1.0 | 1.0 | 8.6 |
| 4 | Fatty alcohol | 2.9 | 3.0 | 7.5 |
| | alkoxylate | | | |

Compounds 1 and 5 show at most minimal signs of a phytotoxic reaction of the tomato plants, whereas the reference substance causes marked reactions. When using the compounds 1 and 5, the mass of the plants formed is not reduced compared to the untreated plant, whereas the plants treated with the reference substance are more poorly developed, i.e. have a lower plant mass.

### Example 15

### Pesticide Preparations, Increase of the Biological Activity of Glyphosate

### Spray Solutions

Compound 1 and compound 5 are tested for their suitability as adjuvant for the herbicide glyphosate by the tank mix method. Here, 50% strength solutions are used. In the case of compound 1, triethanolamine is additionally added to dissolve the acid.

By mixing these tank mix solutions with a commercial aqueous solution of glyphosate isopropylammonium (comprising 62% by weight of the active compound glyphosate IPA salt; IPA: isopropylammonium) and further addition of water, a preparation according to the invention is formed. The ratio of glyphosate (based on the acid equivalent) to adjuvant corresponds to that which is also found in commercially available glyphosate formulations.

For easier monitoring of the adjuvant effects, reduced doses of glyphosate are used; the application rate is 135.2 g a.e./ha glyphosate IPA salt (corresponding to 4.0 mmol or 0.68 g a.e./l at a liquid volume of 200 l/ha). The abbreviation “a.e.” means “acid equivalent”.

The spray solutions comprise the following concentrations of adjuvant: 0.0141% (v/v).

### Plants

Wild oats (Avena fatua, AVEFA) are cultivated in a greenhouse under 14 hours of light irradiation at a temperature of 18/12 (±0.5)° C. (day/night) and a relative atmospheric humidity of 70/80 (±5) % (day/night). Light is introduced via high-pressure mercury lamps and fluorescent tubes, resulting in a power of 70 W/m² (PAR; PAR: photosynthetically active radiation (400-700 nm)) on the leaf level. The plants are cultivated in plastic pots having a diameter of 11 cm, filled with a mixture of sand and soil (Soil No. 12, Colent b.v., Lent, the Netherlands) in a volume ratio of sand:soil=1:2.

The pots are placed on a subirrigation mat which is moistened daily with a nutrient solution of medium strength. After emergence, the AVEFA seedlings are divided into six plants per pot for the activity tests.

### Herbicide Application

The spray solutions are used to carry out greenhouse trials. The effect of the adjuvants on the efficacy of glyphosate is tested.

The spray solutions are applied to the plants using an air pressure-operated laboratory sprayer, such that an application rate of 200 l/ha results.

Wild oats (AVEFA) are treated once they have reached the 2-3 leaf stage.

### Results

The efficacy of the herbicide is assessed after 21 days. To this end, the mass of the remaining above-ground plant parts (fresh weight (FW) in gram) is determined. This is shown in table 3, together with the calculated relative residual amount, compared to the untreated plant (in % by weight).

TABLE 3
The effect of the adjuvants on the
efficacy of glyphosate (AVEFA)

| | | | Mean of | |
|---|---|---|---|---|
| | | | tests 1 | Residual |
| | Test 1 | Test 2 | and 2 | amount |
| | [g FW] | [g FW] | [g FW] | [% by weight] |
| Untreated plant | 11.26 | 14.67 | 12.97 | 100 |
| Glyphosate, no adjuvant | 9.63 | 13.45 | 11.54 | 89 |
| added | | | | |
| Glyphosate + Compound 1 | 7.39 | 11.80 | 9.60 | 74 |
| Glyphosate + Compound 5 | 7.52 | 4.44 | 5.98 | 46 |

### Example 16

### Pesticide Preparations, EC Formulations

Compound 3 and compound 5 are tested for their suitability as emulsifier in EC formulations (emulsifiable concentrates). To this end, pesticide preparations according to the invention comprising the active compounds malathion and cypermethrin are prepared (table 4).

TABLE 4
Malathion and cypermethrin EC formulations

| Formulation | M1 | C1 | C2 |
|---|---|---|---|
| Malathion (95-96%) [g] | 653.4 | — | — |
| Cypermethrin (94%) [g] | — | 23 | 23 |
| Phenylsulfonate CA [g] | 54.45 | 4 | 4 |
| Emulsogen ® 3510 [g] | 27.22 | — | — |
| Emulsogen ® EL 360 [g] | — | 3 | 3 |
| Compound 3 [g] | — | — | 3 |
| Compound 5 [g] | 27.22 | 3 | — |
| Xylene [g] | 326.7 | — | — |
| Solvesso ® 150 [g] | — | 67 | 67 |
| Sum [g] | 1088.99 | 100 | 100 |

Phenylsulfonate CA (Clariant): Calcium dodecylbenzenesulfonate in isobutanol (70% strength)
Emulsogen ® 3510 (Clariant): EO/PO block copolymer
Emulsogen ® EL 360 (Clariant): Castor oil ethoxylate
Xylene: Organic solvent
Solvesso ® 150 (Exxon): Organic solvent

All three preparations are storage-stable EC formulations. To assess the quality of the formulations, 5% strength aqueous emulsions in soft (20 ppm) and hard (342 ppm) CIPAC standard water are prepared and assessed after a period of 2, 4 and 24 hours at 30° C. All emulsions are stable for this period of time, phase separation is not observed.

1. A pesticide preparation, comprising
a) at least one pesticide and
b) at least one N substituted 2-pyrrolidone-4-carboxylic acid derivative.

2. The pesticide preparation as claimed in claim 1, wherein the at least one N substituted 2-pyrrolidone-4-carboxylic acid derivative of component b) is selected from the group consisting of compounds of the formula (Z) 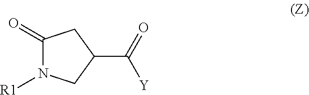
wherein
R1 is C₈- to C₃₀-alkyl or C₈- to C₃₀-alkenyl,
Y is OM, —O—[AO]ₙ—X or NR2R3,
M is hydrogen, an alkali metal or alkaline earth metal, ammonium NH₄⁺ or substituted ammonium, where the substituents at the nitrogen atom of the substituted ammonium are selected from the group consisting of alkyl groups having 1 to 4 carbon atoms and CH₂CH₂OH,
A is C₂- to C₄-alkylene or C₆H₅—(CH—CH₂),
n is a number from 0 to 100,
X is C₁- to C₂₀-alkyl, benzyl or a substituted aryl radical, and, in the case that n is not 0, may be hydrogen,
R2 and R3 independently of one another are hydrogen, C₁- to C₂₀-alkyl or (C₂H₄O)ₚH and
p is a number from 1 to 20.

3. The pesticide preparation as claimed in claim 1, wherein the at least one N substituted 2-pyrrolidone-4-carboxylic acid derivative of component b) is selected from the group consisting of compounds of the formula (1) 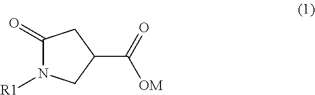
wherein
R1 is C₈- to C₃₀-alkyl or C₈- to C₃₀-alkenyl, and
M is hydrogen, an alkali metal or alkaline earth metal, ammonium NH₄⁺ or substituted ammonium, where the substituents at the nitrogen atom of the substituted ammonium are selected from the group consisting of alkyl groups having 1 to 4 carbon atoms and CH₂CH₂OH.

4. The pesticide preparation as claimed in claim 1, wherein the at least one N substituted 2-pyrrolidone-4-carboxylic acid derivative of component b) is selected from the group consisting of compounds of the formula (2) 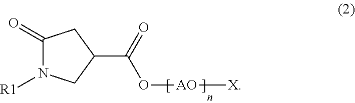
wherein
R1 is C₈- to C₃₀-alkyl or C₈- to C₃₀-alkenyl,
A is C₂- to C₄-alkylene or C₆H₅—(CH—CH₂),
n is a number from 0 to 100, and
X is C₁- to C₂₀-alkyl, benzyl or a substituted aryl radical, and, in the case that n is not 0, may also be hydrogen.

5. The pesticide preparation as claimed in claim 1, wherein the at least one N substituted 2-pyrrolidone-4-carboxylic acid derivative of component b) is selected from the group consisting of compounds of the formula (3) 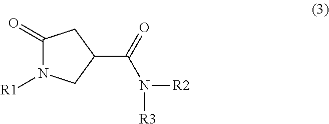
wherein
R1 is C₈- to C₃₀-alkyl or C₈- to C₃₀-alkenyl,
R2 and R3 independently of one another are hydrogen, C₁- to C₂₀-alkyl or (C₂H₄O)ₚH and
p is a number from 1 to 20.

6. A process for improving the performance of a pesticide preparation as claimed in claim 1, comprising the step of adding at least one N-substituted 2-pyrrolidone-4-carboxylic acid derivative to the pesticide preparation.

7. A process for emulsifying a pesticide preparation as claimed in claim 1, comprising the step of adding at least one N-substituted 2-pyrrolidone-4-carboxylic acid derivative to the pesticide preparation.

8. A process for wetting a pesticide preparation as claimed in claim 1, comprising the step of adding at least one N-substituted 2-pyrrolidone-4-carboxylic acid derivative to the pesticide preparation.

9. A process for dispersing a pesticide preparation as claimed in claim 1, comprising the step of adding at least one N-substituted 2-pyrrolidone-4-carboxylic acid derivative to the pesticide preparation.

10. A process for preparing a pesticide preparation as claimed in claim 1, comprising the step of adding at least one N-substituted 2-pyrrolidone-4-carboxylic acid derivative to the pesticide preparation.

11. A process for controlling and/or combating weeds, fungal diseases or infestation by insects, comprising the step of applying at least one pesticide preparation as claimed in claim 1 to the weeds, fungal diseases or infestation by insects.

12. The pesticide preparation as claimed in claim 2, wherein M is a mono-, di- and trisubstituted ammonium.

13. The pesticide preparation as claimed in claim 2, wherein X is selected from the group consisting of at least one phenyl substituted by 1 to 3 substituents, wherein the substituents are selected from the group consisting of alkyl groups having 1 to 4 carbon atoms and styryl.

14. The pesticide preparation as claimed in claim 3, wherein M is a mono-, di- and trisubstituted ammonium.

15. The pesticide preparation as claimed in claim 4, wherein X is selected from the group consisting of at least one phenyl substituted by 1 to 3 substituents, wherein the substituents are selected from the group consisting of alkyl groups having 1 to 4 carbon atoms and styryl.
